(19) United States
(12) Patent Application Publication
(10) Pub. No.: US 2008/0255911 A1
(43) Pub. Date: Oct. 16, 2008

(54) Method and system for adaptive closed loop resource management

(75) Inventor: Deepak Khosla, Camarillo, CA (US)

Correspondence Address: PEARSON & PEARSON, LLP, 10 GEORGE STREET, LOWELL, MA, 01852, US

(73) Assignee: Raytheon Company, Waltham, MA (US)

(21) Appl. No.: 11/786,906

(22) Filed: Apr. 13, 2007

(51) Int. Cl. G06F 9/46

(52) U.S. Cl. 705/8

(57) ABSTRACT

A method and system provide closed loop management control of multiple sensors that receive kinematic, classification and search measurement inputs regarding targets being tracked by the sensors during a measurement cycle in addition to performance requirements inputs. The kinematic, classification and search needs and gains are computed by the system resulting in corresponding entropy outputs which are combined to provide outputs defining joint information need and gains. Based on the joint information need and gains outputs, the system pairs each track with a possible sensor for making measurements during the next measurement cycle and repeats the process this process until all performance goals have been achieved for optimally satisfying the information need requirements for accurate target detection, tracking and classification.

### RELATED APPLICATION

This non-provisional patent application is being filed concurrently with the non-provisional application entitled “A SPARSE SAMPLING PLANNER FOR SENSOR MANAGEMENT”, Atty. Docket No. 34287, bearing application Ser. No. ______.

### BACKGROUND OF THE INVENTION

1. Field of the Invention

The invention relates generally to systems that make decisions based on collected information to control resources. In particular, the invention relates to applications that require allocation and scheduling of resources to satisfy one or more time critical objectives.

2. Description of Related Art

The use of multi-sensor systems has led to a tremendous increase in the amount of data requiring processing. The number, types and agility of sensors along with the increased quality and timeliness of data far outstrip the ability of an operator to control them. With all the different types of sensors and data, it is often difficult to compare how much information can be gained through a given-sensor scheduling scheme. Also, there has been an increasingly complex world, in terms of targets that must be detected, tracked and identified and where tracking objectives can move from simply trying to achieve the most with a limited sensor resources to developing the ability to achieve more specific tracking goals, such as reducing the uncertainty in a target estimate enough to accurately fire a weapon at a target or to ensure that a mobile robot does not collide with an obstacle This has led to the sensor management efforts. Systems tracking multiple targets often do no have the sensing or computational resources to apply all sensors to all targets in the allocated time intervals. Thus, the problems that sensor management has to deal with include insufficient sensor resources, highly dynamic environment, varied sensor capabilities/performance, failures and enemy interference, etc.

Information-theoretic measures such as entropy for sensor management have been used for many years. This area has focused primarily on managing sensors to maximize kinematic information gain only. Examples include: a first article titled “Information Based Senor Management” by W. Schmaedeke published in Signal Processing, Sensor Fusion, and Target Recognition II Proceedings of the SPIE—The International Society for Optical Engineering, vol. 1955, Orlando, Fla., Apr. 12-14, 1993 at pp. 156-164 and a second article titled “Information Based Sensor Management and IMMKF,” by W. Schmaedeke and K. Kastella published in Signal and Data Processing of Small Targets 1988, Proceedings of the SPIE—The International Society for Optical Engineering, vol. 3373, Orlando, Fla., April, 1988, pp. 390-401.

Others have described techniques for managing sensors to maximize identification (ID) as well as search. Examples include a first article titled “Discrimination Gain to Optimize Detection and Classification” by K. Kastella, published in the IEEE Transactions on Systems, Man and Cybernetics, Part A: Systems and Humans, vol. 27 no. 1 at pp 112-116 and a second article titled “An Information Theoretic Approach to Sensor Scheduling” by G. A. McIntyre and K. J. Hintz published in Signal Processing, Sensor Fusion and Target Recognition V Proceedings of the SPIE—The International Society for Optical Engineering, vol. 2755, Orlando, Fla., Apr. 8-10, 1996, at pp. 304-312.

The basic objective of above methods and systems has been to obtain measurements from sensors that maximize the information gain in the context of conducting operations either in a search mode or in a tracking mode. In such systems, all gains are computed separately without any consideration being given to the current situation and system performance. That is, the goal has been to obtain as much information as possible. Further, prior art methods and systems have either addressed single sensor control problems or dealt with one or two objectives that are handled at independent levels.

The above discussed systems are illustrative of the open-loop approach that has been employed to sensor management. In such open-loop sensor management systems, the approach has been to select sensors that maximize information gain. Also, open-loop approaches that use of decision trees such as fuzzy logic for multi-management have also been proposed. An example of this approach is described in the article titled “Fuzzy Reasoning for Multisensor Management” by J. M. Molina Lopez, F. J. Jimenez Rodriguez and J. R. Casar Corredera published in IEEE Conference on Systems, Man and Cybernetics, vol. 2, Vancouver, British Columbia, Canada, Oct. 22-25, 1995 at pp. 1398-1403.

Recently, a technique has been described for managing sensors for closed loop-control. But, this technique is based only on kinematic need and is calculated based on current kinematic track state and desired kinematic accuracy. Sensor gains are calculated and sensors are scheduled according to kinematic need and gain. Thus, this technique is not suitable for handling general system problems. For more information about this technique, reference may be made to the article titled “Covariance Control for Multisensor Systems” by M. Kalandros and L. P. Pao published in IEEE Transactions Aerospace Electronic Systems, vol. 38, No. 4, 2002.

It is an object of the present invention to overcome the limitations of prior art sensor management approaches that are not suited for achieving specific disparate control objectives.

### SUMMARY OF THE INVENTION

The system and method of the preferred embodiment is able to control the acquisition of data by multiple heterogeneous co-located or spatially distributed sensors to meet a set of mission goals simultaneously. The sensor management system and method of the present invention is important in terms of the benefits it provides over non-coordinated sensor operation by automating the sensor management process in a way that the sensor management process can be formulated in terms of a classic mathematical optimization and scheduling problem. This opens up an arsenal of advance techniques for implementing different functions performed by a closed-loop sensor management system. In accordance with the teachings of the present invention, all information needs and sensor applicability (information gains) are defined in terms of mathematical values using an information-theoretic framework. More specifically, the method and system of the present invention incorporates quantitative metrics for search, track/kinematic and identification performance requirements (desired goals) as well as the single framework for automatically combining them. By mapping all needs/gains to applicable sensors in terms of an exact mathematical formulation and value, better sensor management and system performance is achieved.

Also, the use of a single information-theoretic framework by the method and system of the present invention enables use of different kinds of sensor optimization/scheduling methods (e.g. greedy algorithm, short-term, long-term planners etc.). The method and system of the present invention enables assignment of priorities to search, kinematic/track and identification goals by defining such priorities as weighing terms to the information needs of search, kinematic/track and identification terms after they have been scaled and combined in terms of a single metric or information-theoretic domain. Thus, both combination and prioritization of information needs of search, kinematic/track and identification needs can be done in a single rigorous mathematical framework making the closed-loop sensor management system of the present invention fully automated without the use of ad-hoc parameters or human intervention being required.

In the case where human or operator intervention is desired, the operator defines the sensor tasking criteria instead of controlling multiple sensors individually by specifying each operation to be performed by each sensor. Thus, the operator is able to concentrate on the overall objective or mission while the system works on the details of the sensor operations. For example, the system is able to provide a user or operator with a list of prioritized tasks for action which is based on needs wherein the same single metric is used to identify what actions will best satisfy such needs.

The term “need” is used herein to denote whether or not there is enough information to make a sufficient classification/identification of a particular target or object. Thus, “need” can be viewed as the amount of information still needed to get a track's kinematic or classification state up to the desired system performance goals. For example, if a computed need is positive, it means that there is not enough information presently and more information is needed.

The above and further advantages of the present invention may be better understood by referring to the following description in conjunction with the accompanying drawings, in which like numerals indicate like structural elements and features in various figures. The drawings are not necessarily to scale, emphasis instead being placed upon illustrating the principles of the invention.

### BRIEF DESCRIPTION OF THE DRAWINGS

FIG. 1a is a block diagram illustrating the operational flow and components of the system of the preferred embodiment of the present invention.

FIG. 1b shows additional outputs provided by specific modules within the system of FIG. 1a.

FIG. 2 shows in block form, the functional architecture of the system of FIG. 1a according to the present invention.

FIG. 3a is a flow chart used to explain the operating principles of the system of FIG. 1 a according to the present invention.

FIG. 3b is a flow chart that shows in greater detail, some of the operations set forth in the flow chart of FIG. 3a.

FIG. 4 is a drawing illustrating a simulation model architecture of a testbed tool used in demonstrating the principles of the present invention.

FIG. 5 illustrates the testbed tool simulation while conducting a particular scenario.

FIGS. 6a and 6b illustrate the results obtained from the simulation shown in FIG. 5.

### DETAILED DESCRIPTION OF THE PREFERRED EMBODIMENT OF THE PRESENT INVENTION

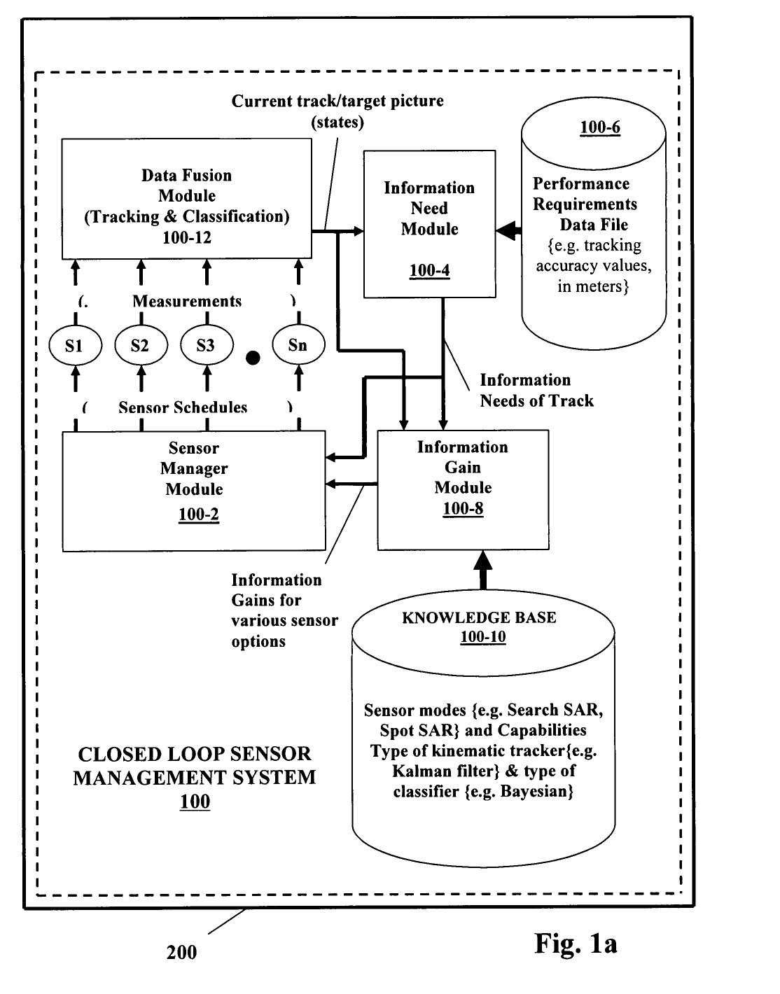

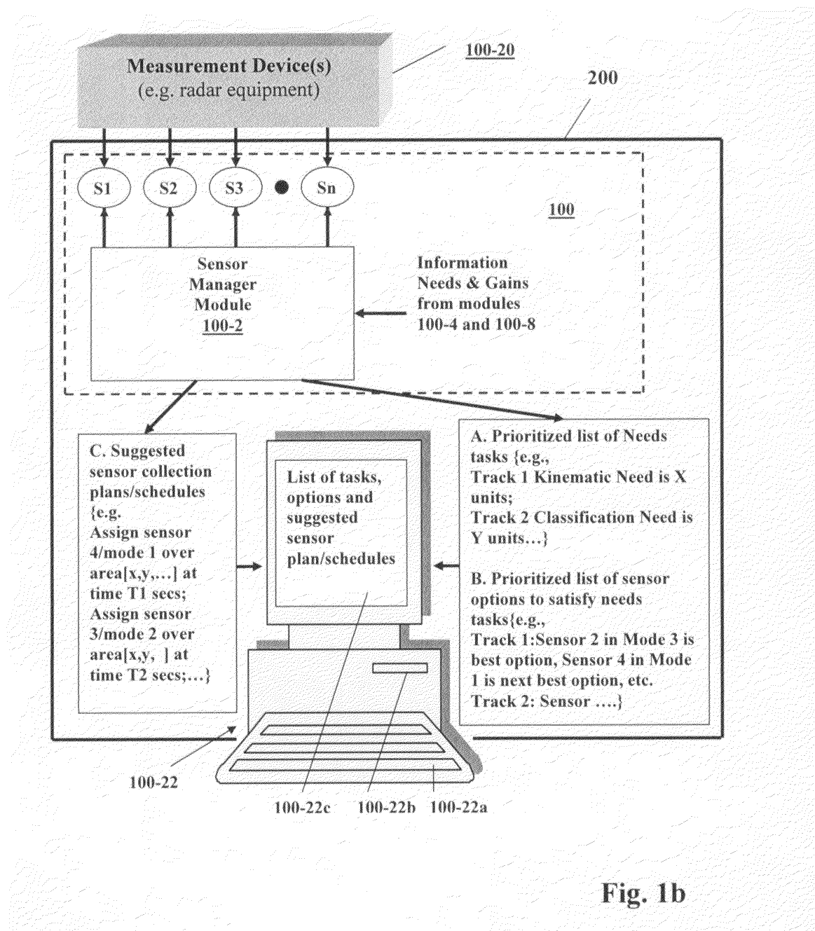

FIG. 1a shows the closed loop sensor management system of the preferred embodiment of the present invention. In typical tracking and surveillance situations, the environment is comprised of a set of targets and their states. These target states can be divided into those that have not been detected and those that have been detected and are, or will soon be in “track”. Targets that are in track have varying kinematic and identification accuracies. Targets that are not yet detected need more sensor search time to increase the chance of detection. Typically, the total area under searched can be divided into sectors (and subdivided into cells). In accordance with the teachings of the present invention, performance goals are established by the system. Broadly speaking, the system performance goals can be divided into search, kinematic tracking and identification/classification goals with quantitative performance requirement specifications on each goal.

At the end of the specification, a glossary of terms has been included for the reader. These definitions are not intended to convey the full scope of the terms with respect to the present invention, but are provided to give the reader a general understanding of the terms and to serve as a central location to which the reader can refer.

### Description of FIGS. 1a and 1b

As illustrated in FIG. 1a, the system 100 includes a plurality of modules 100-2, 100-4, 100-8 and 100-12 which are operatively connected to form a closed loop sensor management system. The system 100 forms part of a computer system 200 that includes a plurality of interconnected processors (not shown) that may be either general purpose or specialized for use with the system 100 that are programmed to carry out the functions of different ones of the modules 100-2 through 100-8. The necessary program instructions required to carry out the operations of the modules of system 100 are loaded or entered into the system 200 from disk such as file 100-6 or a workstation such as shown in FIG. 1b or other means well known in the art. The computer system 200 receives information from multiple sensors which it passes on to system 100 via its inputs. Such inputs may include multiple “ports”.

As shown, a plurality of sensors represented as S1, S2, and S3 through Sn in FIG. 1a operatively couple to and are under the control of sensor manager module 100-2. As indicated in FIG. 1b, the sensors S1 through Sn make measurements on the targets through measurement device equipment 100-20 (e.g. radar equipment) to which they operatively couple for receiving information signals. It will be appreciated that the location of such equipment 100-20 and sensors depends on the particular system application and hence is not relevant to understanding the teachings of the present invention.

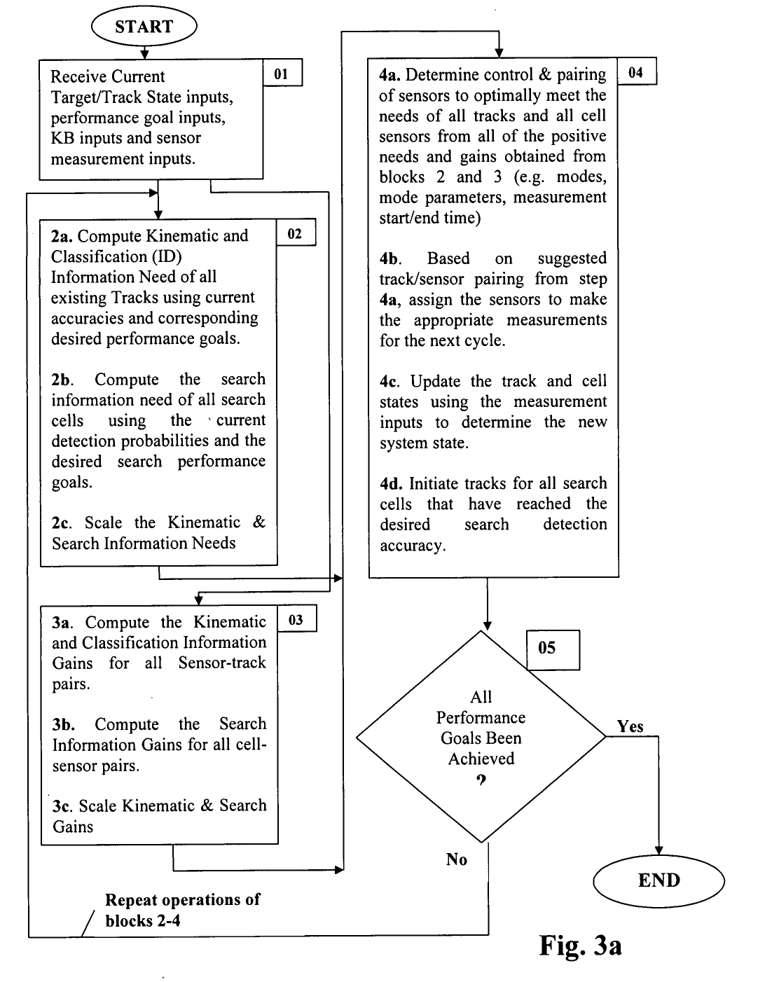

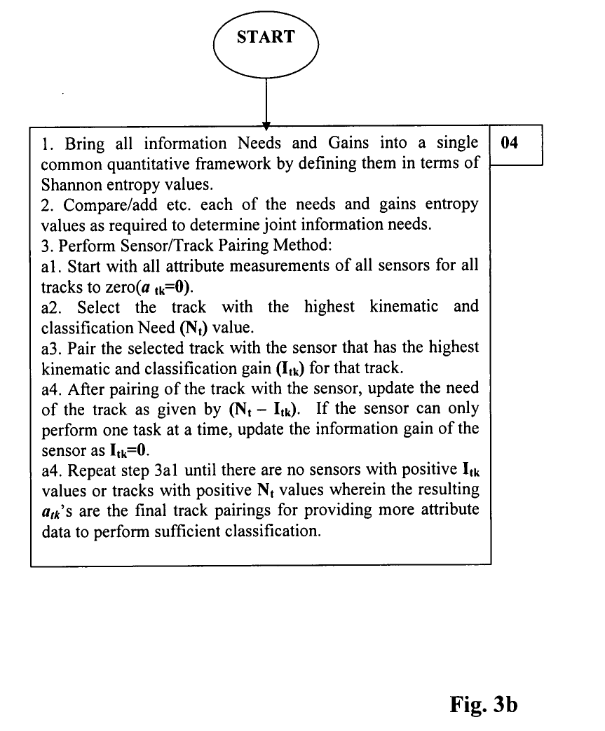

Information need module 100-4 assesses the current system state and performance requirements obtained by accessing a performance requirements data file 100-6 as shown in FIG. 1a. As discussed herein, the data file 100-6 contains requirements criteria previously established by an operator via a workstation device 100-22 of FIG. 1b to be used assessing achievement of system performance goals. Also, the workstation 100-22 provides feedback to the operator relative to system performance and scheduled tasks being carried out. As shown in FIG. 1b, the operator is provided a list of tasks, options and suggested sensor plan/schedule that are set forth as items A, B and C. This will be discussed herein in greater detail relative to the operation of the preferred embodiment in connection with FIGS. 3a and 3b.

In greater detail, the workstation 100-22 is conventional in design and includes a keyboard 100-22a, a disk drive unit 100-22b and a monitor/display unit 100-22c. The keyboard 100-22a and disk drive unit 100-22b can be used for entering program instructions into the system 100. The display unit 22c as discussed is used for displaying task/option information received from sensor manager module 100-2

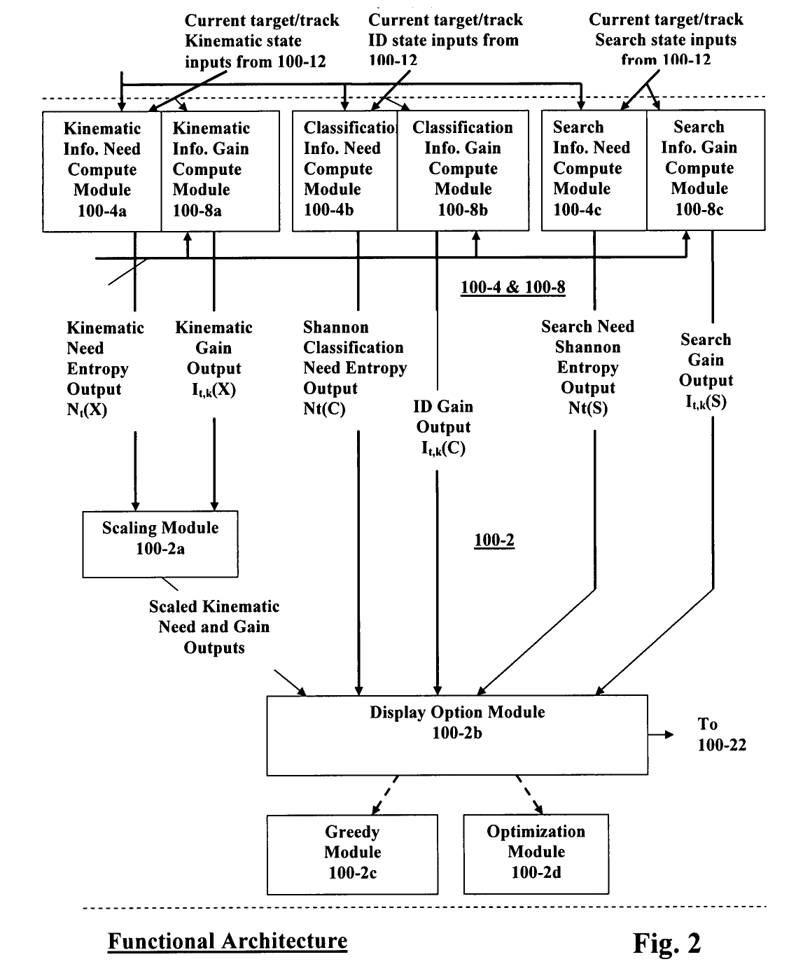

The module 100-4 generates a plurality of different disparate outputs indicating the information needs of the tracks which are applied as inputs to information gain module 100-8. The information gain module 100-8 using information defining the sensor capabilities and constraints obtained from accessing a knowledge base file 100-10 computes the information gains for the various sensor options. This information is applied as an input to the sensor manager module 100-2 which in turn generates output signals defining suggested sensor collection plans/schedules of sensor tasks as illustrated in FIG. 1b. Although, the flow of modules 100-4 and 100-8 is depicted as sequential, as illustrated in FIG. 2, the modules operate in parallel in generating the various outputs as described herein. The sequential flow in FIG. 1 takes into account a special case if the information need value is less than or equal zero in which there is no requirement to compute information gain.

In system 100 of the preferred embodiment, the output signals representative of suggested sensor collection plans/schedules generated by module 100-2 correspond to commands that include parameters such as platform (sensor) number, task start time, mode type (e.g. search SAR, spot SAR and GMTI) and mode parameters (e.g. center coordinates of coverage area (patch) and coverage area (patch) size. An example of such commands is: Sensor S1: collect in GMTI mode over area X for the next T seconds; Sensor S2: Collect in search SAR mode over area Y, etc. A further example of such commands is indicated in FIG. 1b. As shown, such commands may take the following form: Assign sensor4/mode 1 over area{x,y, . . . ] at time T seconds.; Assign sensor3/mode 2 over area [x,y, . . . ] at time T2 seconds; etc. Additionally, these commands could include:
A. Prioritized list of Needs tasks {e.g.,

Track 1 Kinematic Need is X units;

Track 2 Classification Need is Y units . . . }
B. Prioritized list of sensor options to satisfy needs tasks {e.g.,

Track 1: Sensor 2 in Mode 3 is best option; Sensor 4 in Mode 1 is next best option, etc;

Track 2: Sensor 1 in Mode 2 is best option . . . }.

As shown in FIG. 1a, the sensors S1 through Sn operatively couple to data fusion module 100-12 which includes a Kalman filter network module and a Bayesian engine module. The module 100-12 receives sensor signals corresponding to kinematic and classification/ID measurements from sensors S1 through Sn and using the Kalman filter network module takes kinematic measurements data and fuses them with the existing track state to create a new track state. The Bayesian engine module takes sensor classification measurements data and fuses them with the current classification state to produce a new classification state. As shown in FIG. 1a, signals representative of the current track states are applied as inputs to the information need and gain modules 100-4 and 100-8 respectively which performs the operations discussed above.

### Description of FIG. 2

FIG. 2 shows the functional architecture of the system 100. As shown, the architecture includes several groups of Need and Gain computation modules 100-4a through 100-2c which are interoperably related and form part of different ones of the modules of FIG. 1a. A first group of modules 100-4a through 100-4c form part of the information need module 100-4 of FIG. 1a. In response to the different track states inputs from fusion module 100-12 and performance requirements inputs from data file 100-6 shown, these modules compute track kinematic, classification and search information need for any sensor in response to discrete and continuous state input signals and provide outputs in the form of Need entropy output signals Nₜ, (X) Nₜ. (C) and Nₜ(S). As discussed herein, the classification Need module 100-4b may be implemented by any one of three embodiments.

A second group of modules 100-8a through 100-8c form part of the information gain module 100-8 of FIG. 1a. This group of modules 100-8a through 100-8c in response to the different current track states inputs from fusion module 100-12 and inputs from knowledge base 100-10 such as information about the sensors, their capabilities and operational modes and measurement accuracies of such modes, compute track kinematic, classification (ID), and search information gain for any sensor and produce outputs in the form of Gain output signals I_{t,k}(X), I_{t,k}(C) and I_{t,k}(S).

A third group of modules 100-2a through 100-2d form part of the sensor manager module 100-2 of FIG. 1a. The scaling module 100-2a scales the kinematic (differential) entropies to produce the scaled kinematic need and gain outputs as indicated in FIG. 2 relative to related quantities (i.e. classification and search) so as provide a common metric reference system and framework. This enables the module 100-2 to directly compare and combine the kinematic, classification and search values by in a manner for determining joint information needs and gains used in achieving optimal sensor control as discussed herein.

The modules 100-2c and 100-2d represent examples of two different methods/embodiments of carrying out a planning/schedule algorithm function which provides final sensor-track pairings for achieving optimum sensor management control. Only one of these modules would be selected to operate in the system 100. Both modules take into account both the need and gain in order to achieve optimal control. The module 100-2c is implemented to perform a near-term or myopic/greedy planner function wherein it operates to maximize instantaneous expected information gain. It does this by evaluating each assignment of actions to the sensors (i.e. such an assignment is called a joint action) by computing the expected identification information gain and kinematic information gain for each track given the joint action.

The module 100-2d implements a global optimization method for determining those sensor/track pairings that maximizes values of achieved information need so as to achieve the best overall information objective as discussed herein. In each embodiment, the planner optimizes sensor tasking and scheduling, in near real-time, to best meet user information needs collection and mission requirements over short-term planning cycles. It will be appreciated that other forms of planners could also be used (e.g. long-term planners). An example of such a planner is described in an article entitled “A sparse sampling planner for sensor resource management” by Matthew Rudary, Deepak Khosla, James Guillochon, Alex P. Dow and Barbara Blyth which appeared in the publication: Signal Processing, Sensor Fusion, and Target Recognition XV. Edited by Ivan Kadar, Proceedings of the SPIE, Volume 6235, pp. 62350A (2006) dated June 2006. The contents of the cited article are hereby incorporated by reference into this patent application.

As shown in FIG. 2, different modules of the system 100 utilize Kalman Filter Networks and Bayesian networks for carrying out the functions of their associated modules. These networks are used for determining the kinematic state of each track and the identification/classification of the track. The following describes the application of these well known types of devices in providing the required signals for carrying out the different module functions. The compute modules of the system of the present invention may be implemented by processors programmed to carry out the computations necessary for producing entropy outputs according to the teachings of the present invention. Such processors would be included as part of system 200 of FIG. 1. The required program instructions are loaded into the memory of each such processor in a conventional manner via the workstation 100-22 of FIG. 1b. Alternatively, such program instructions could be preloaded onto other files within system 200 and downloaded to system 100 in a conventional manner.

Track State (Kinematic) The kinematic state of each track is modeled by a linear dynamical system and tracked with a Kalman filter network. It will be appreciated that it could be modeled by any generative model whose state can be estimated from observational data. The dynamics of the linear dynamical system are governed by the following equations.

Xₜ=ΦXₜ₋₁+wₜ (1)

wₜ˜N(0,Q) (2)

Here, Xₜ (i. e. a column vector) is the state of one of the tracks at time t. (If it is necessary to refer to the state of a particular track, i, a superscript is added: Xₜⁱ; the tracks are independent of each other) Φ and Q are parameters of the system, and N(m, Σ) denotes the multivariate normal distribution with mean vector m and covariance matrix Σ. If the track is observable at time t by sensor j (which depends on the state of the track and the action selected for the sensor), then a kinematic observation (z_{t,j}) is generated according to:

z_{t,j}=H_{t,j}Xₜ+v_{t,j} (3)

v_{t,j}˜N(0,R_{t,j}) (4).

Here, H_{t,j} determines what is measured by the sensor and R_{t,j} is a measure of the accuracy of the measurement. Zₜ is defined to be the set of all the kinematic observations of a track at time t.
Since Xₜ is unobservable, it must be estimated through the use of a Kalman filter network. The Kalman filter maintains a least-squares estimate x(t|t)=E[Xₜ|Zₗ, . . . , Zₜ] and a covariance matrix P(t|t)=E[x(t|t)x^{T}(t|t)|Zₗ, . . . , Zₜ] of the error. This is recursively maintained through the following sets of equations:

x(t|t−1)=Φx(t−1|t−1) (5)

P(t|t−1)=ΦP(t−1|t−1)Φ^{T}+Q (6)

$$\begin{matrix}{P}^{- 1} ( t \vert t ) = {P}^{- 1} ( t \vert t - 1 ) + {\sum }_{j = 1}^{S} {χ}_{t , j} {H}_{t , j}^{T} {R}_{t , j}^{- 1} {H}_{t , j} & ( 7 ) \\ x ( t \vert t ) = P ( t \vert t ) ( {P}^{- 1} ( t \vert t - 1 ) x ( t \vert t - 1 ) + {\sum }_{j = 1}^{S} {χ}_{t , j} {H}_{t , j}^{T} {R}_{t , j}^{- 1} {z}_{t , j} ) & ( 8 )\end{matrix}$$

where χ_{t,j} is an indicator variable that is 1 when sensor j produces a kinematic observation of the track at time t and 0 otherwise.

Track State (Classification) As with the kinematic state, the identification of the track can be reasoned by applying Bayesian reasoning through the use of a Bayesian network. It will be appreciated that there are a number of other ways of implementing such reasoning. The sensors are modeled using confusion matrices. The klth element of Θ_{t,j} gives the probability at time t that sensor j reports the track as type k when it is type l. The uncertainty is modeled as a multinomial distribution; the kth element of the belief state b(t) is the belief (i.e. probability) at time t that the track is type k, given all the observations that have come up to (and including) time t. If the track is observable at time t by sensor j, then an identification observation (o_{t,j}) is produced. Oₜ is taken to be the set of all of the identification observations of a track at time t.

Let Θ(o,t,j) be the diagonal matrix whose kkth element is the probability that sensor j would produce observation o at time t given that the track is of type k (i.e. the diagonal of this matrix is the oth row of Θ_{t,j}). Then the belief state can be updated with the following equation:

$$b ( t + 1 ) = ( {\prod }_{j = 1}^{S} {Θ ( o , t , j )}^{{κ}_{t , j}} ) \frac{b ( t )}{Γ} \qquad ( 9 )$$

where κ_{t,j} is an indicator variable that is 1 when sensor j produces an identification observation of the track at time t and 0 otherwise, and Γ is a normalizing constant (the elements of b(t+1) must add to 1).

### DETAILED DESCRIPTION OF THE INVENTION MODULES OF FIG. 2

(A) Information Need Based on Performance Goals The following describes in greater detail, the metric and framework provided by the modules of FIG. 2 for determining information need for kinematic, classification attributes/features, and search objectives based on established system goals. One embodiment component is then described which combines these disparate needs and brings them into a common framework.

Kinematic Information Need-Module 100-4a The following describes when given track kinematic states, how to determine the information need for each track based on desired kinematic performance requirements according to the teachings of the present invention. The desired kinematic performance is usually specified in the form of tracking accuracy as for example, in terms of Circular Error Probable values (e.g. 5m CEP) obtained from performance requirements file 100-6.

The differential entropy of a continuous random variable X with density f(x) where x is defined over a region I is given by the following:

H(X)=E[−log f(x)]=−∫f(x)log(f(x))dx (1a).

For a normal random variable (discrete) with mean μ and variance σ²:

$$\begin{matrix}f ( x ) = \frac{1}{\sqrt{2 {πσ}^{2}}} exp ( - \frac{{( x - μ )}^{2}}{2 {σ}^{2}} ) . & ( 2 a ) \\ H ( X ) = - {\int }_{- ∞}^{+ ∞} f ( x ) log ( f ( x ) d x = \frac{1}{2} {log}_{2} ( 2 πe {σ}^{2} ) . & ( 3 a )\end{matrix}$$

For a multivariate normal random variable (continuous) with covariance C, the differential entropy is:

$$H ( X ) = \frac{1}{2} {log}_{2} ( 2 πe \vert C \vert ) . \qquad ( 4 a )$$

wherein the absolute value of C is the determinant of C. Entropy can also be viewed as a measure of system uncertainty or information state.

In a Kalman filter typically used in kinematic tracking operations, the state vector is assumed to be a normal random vector and covariance estimate at any time step (cycle) is a measure of the estimation uncertainty in the state vector. The entropy decreases with new measurements because the estimation uncertainty goes down. If the current state covariance matrix is denoted as P_{before} and the desired covariance matrix by P_{d} as specified by the performance requirements, then the desired information need is the difference between the current and desired entropies and is given as follows:

$${N}_{t} ( X ) = {H}_{before} ( X ) - {H}_{d} ( X ) = {log}_{2} ( \frac{\vert {P}_{before} \vert}{\vert {P}_{d} \vert} ) . \qquad ( 5 a )$$

It will be noted that desired information need Nₜ is positive as long as the desired covariance has not been achieved. Tracks with high Nₜ-values need kinematic sensor measurements urgently. Additionally, track priority Pₜ provided as supplemental information can be lumped into track need as follows:

$${N}_{t} ( X ) = {P}_{t} {log}_{2} ( \frac{\vert {P}_{before} \vert}{\vert {P}_{d} \vert} ) . \qquad ( 6 a )$$

Equation (6a) is a measure of the kinematic information need of a target (track). If it is assumed that there are T existing tracks, the need Nₜ for t=1, . . . ,T of each track can be computed using Equation (6a). As shown, the track priority, current covariance and desired covariance are needed to compute the track kinematic information need.

Classification (Identification) Information Need-Module 100-4b The following describes when given current track classification states, how to determine the information need of each track based on desired performance requirements. The desired classification performance is usually specified in the form of probability of correct identification (ID) as for example, 98% obtained from performance requirements file 100-6:

It is assumed that C represents the set of M track classes: C={c₁, c₂, . . . c_{M}}.

It is assumed that N represents a set of N discrete attributes:

A=A={a₁,a₂, . . . a_{N}}.

Further, it is assumed the sensors classify targets based on measured attributes wherein only one attribute is measurable by one sensor at a single sampling time. It is assumed that a sensor k is characterized by the M×N confusion matrix Mₖ (representative of a complete conditional probability table) whose elements m_{k,ij} are the class-attribute relation probabilities:

m_{k,ij}=pₖ(aᵢ/cⱼ) ∀i=1, . . . N, j=1 . . . M (7a).

It is assumed that at a given time instant, the target classification of a track t is given by a probability distribution P={p(c₁), (p(c₂), . . . p(c_{M})}, where p(cⱼ) is the probability that the correct class is cⱼ. Then, the current target classification entropy is:

$${H}^{t} ( C ) = - {\sum }_{j = 1}^{M} p ( {c}_{j} ) {log}_{2} p ( {c}_{j} ) \qquad ( 8 a )$$

As discussed above, the desired performance requirement on track accuracy is stated as the “probability of correct ID”. This requirement can be interpreted in terms of entropy in the following several ways. In accordance with the present invention, the following three embodiments are described that can be used to quantify performance requirements based on classification entropy (i.e. to translate goal classification into goal classification information state).

1. The probability of correct ID P_{c} of a target is the same as the posterior probability of the class (ID) of the class with highest probability determined by the system. This is the class with the highest probability among all possible classes for that target, assuming that there is a declaration of a track ID. For convenience, this class is denoted as c,. In order to calculate the desired entropy, the probabilities of all other classes for this target are also needed. An upper and lower bound can be calculated for this entropy based on the probabilities of the remaining classes. The upper bound corresponds to the case when all remaining classes are equi-probable. The lower bound corresponds to the case when only one of the remaining classes has all the leftover probability (1−P_{c}). These are defined as follows:

### Upper Bound:

$$p ( {c}_{1} ) = {P}_{c} p ( {c}_{i} ) = \frac{1 - {P}_{c}}{M - 1} ∀ i = 2 , … M . \qquad ( 9 a )$$

The upper bound of the desired entropy is:

$${H}_{d , upper} ( C ) = - {P}_{c} {log}_{2} {P}_{c} - {\sum }_{j = 1}^{M - 1} ( \frac{1 - {P}_{c}}{M - 1} ) {log}_{2} ( \frac{1 - {P}_{c}}{M - 1} ) \qquad ( 10 a )$$

### Lower Bound

i p(c₁)=P_{c}, p(cⱼ)=(1−P_{c}), p(cᵢ)=0 ∀i=2, . . . M, i≠j (11a).

The lower bound of the entropy is:

H_{d,lower}(C)=−P_{c} log₂ P_{c}−(1−P_{c})log₂(1−P_{c}) (12a).

The desired entropy H_{d} is bounded by:

H_{d,lower}(C)≦H_{d}(C)≦H_{d,upper}(C) (13a).

An example is as follows:
For M=3 and desired probability of correct ID P_{c}=90%,
Upper: p(c₁)=0.9, p(c₂)=p(c₃)=0.05, H_{d,upper}(C)=0.569.
Lower: p(c₁)=0.9, p(c₂)=0.1, p(c₃)=0, H_{d,lower}(C)=0.469.
0.469≦H_{d}(C)≦0.569

2. If there is a fully characterized system where a function relating the probability of correct ID vs. the posterior probability of declared ID which is the probability of the class or ID with the highest probability is available, then the declared ID probability corresponding to P_{c} can be obtained from this function (referred to as receiver operating curve or ROC). This probability is designated as P_{d}. The upper and lower bounds of the desired entropy can be calculated by replacing P_{c} in Equations 10 and 12 with P_{d} which gives the following:

$${H}_{d , upper} ( C ) = - {P}_{d} {log}_{2} {P}_{d} - {\sum }_{j = 1}^{M - 1} ( \frac{1 - {P}_{d}}{M - 1} ) {log}_{2} ( \frac{1 - {P}_{d}}{M - 1} ) . \qquad ( 14 a )$$

H_{d,lower}(C)=−P_{d} log₂ P_{d}−(1−P_{d})log₂(1−P_{d}) (15a).

An example is as follows:

For M=3 and a desired probability of correct ID P_{c}=90%, let the corresponding P_{d} from the below system characteristics curve be 95%.

3. A third interpretation of the probability of correct ID is as a measure of confidence. Confidence is defined here as a number in the range of 0-1 and is given as the ratio of the difference between the highest class probability and the second highest class probability to the highest probability. Thus, this is represented as follows:

$${P}_{c} = \frac{{P}_{HC} - {P}_{SHC}}{{P}_{HC}} \\ {P}_{HC} = Probability of class with highest probability \\ {P}_{SHC} = Probability of class with second highest probability . \qquad ( 16 a )$$

The probabilities and the bounds on desired entropy can be calculated as follows:

### Upper Bound:

$$\begin{matrix}p ( {c}_{1} ) = {( 1 + ( M - 1 ) ( 1 - {P}_{c} ) )}^{- 1} , p ( {c}_{j} ) = \frac{( 1 - {P}_{c} )}{( 1 + ( M - 1 ) ( 1 - {P}_{c} ) )} ∀ j = 2 , … , M . & ( 17 a ) \\ {H}_{d , upper} ( C ) = {( 1 + ( M - 1 ) ( 1 - {P}_{c} ) )}^{- 1} log 2 \text{(} ( 1 + ( M - 1 ) ( 1 - {P}_{c} ) ) - ( M - 1 ) \frac{( 1 - {P}_{c} )}{( 1 - ( M - 1 ) ( 1 - {P}_{c} ) )} log 2 ( \frac{( 1 - {P}_{c} )}{( 1 + ( M - 1 ) ( 1 - {P}_{c} ) )} ) . & ( 18 a )\end{matrix}$$

### Lower Bound:

$$\begin{matrix}p ( {c}_{1} ) = {( 2 - {P}_{c} )}^{- 1} , p ( {c}_{j} ) = \frac{( 1 - {P}_{c} )}{( 2 - {P}_{c} )} , p ( {c}_{i} ) = 0 ∀ j = 2 , … , M , i \neq j . & ( 19 a ) \\ {H}_{d , lower} ( C ) = {( 2 - {P}_{c} )}^{- 1} log 2 ( 2 - {P}_{c} ) - \frac{( 1 - {P}_{c} )}{( 2 - {P}_{c} )} log 2 ( \frac{1 - {P}_{c}}{2 - {P}_{c}} ) . & ( 20 a )\end{matrix}$$

An example is as follows:
For M=3 and desired confidence=90%,
Upper: p(c₁)=0.833, p(c₂)=p(c₃)=0.08333, H_{d,upper}(C)=0.8169
Lower: p(c₁)=0.909, p(c₂)=0.0909, p(c₃)=0, H_{d,lower}(C)=0.4396
0.4396≦H_{d}(C)≦0.8169

For any of the above embodiments (interpretations), the desired classification information need Nₜ(C) of a track t is the difference between the current and desired entropy:

Nₜ(C)=Hₜ(C)−H_{t,d}(C) (21a).

It should be noted that the H_{t,d}(C) above is really H_{d}(C) with the added t subscript denoting track t. In general, the lower bound (tighter bound) of entropy is used as a measure of the desired entropy. It will be noted that three different approaches (embodiments) to determine entropy have been presented. Any one of these three approaches can be used in the system of the present invention. Tracks with high Nₜ values are in more urgent need of ID or attribute measurements. Track priority P provided by supplemental information additionally can be lumped into track need as follows:

Nₜ(C)=Pₜ(Hₜ(C)−H_{t,d}(C)) (22a).

Equation (22a) is a measure of ID information need of a target (track). If there are T existing tracks, then the need Nₜ ∀t=1, . . . ,T can be computed for each track using Equation (22a). It can be seen that the track priority, current classification entropy and desired classification entropy are all needed to compute the track classification information need.

Search Information Need-Module 100-4c Given a search scenario with the some current state, the information need of each sector based on desired performance requirements is determined as follows. The search case is a special case of the ID case with the exception that here the system is trying to classify a cell as target present or not present. Thus, the sensor measurement is either target detected or not detected. Hence, C and A are still valid with these different definitions.

The Area of Interest (AOI) is divided into N cells where each cell contains at most one target. This situation is very similar to the track ID approach with the difference being that the number of discrete states is M=2 (Target present in cell or Target not present in cell) and N=2 (the attributes take on the role of declaration by the sensor as Target detected or Target not detected). Mathematically, this can be stated as follows:

C={c₁,c₂}={Target, No Target present}={T, T_{N}}

A={a₁,a₂}={Target detected, Target not detected}={T_{D}, T_{ND}}

The M×N confusion matrix Mₖ (complete conditional probability table) for sensor k, whose elements m_{k,ij} are the relation probabilities, is as follows:

m_{k,ij}=pₖ(aᵢ/cⱼ)vi=1, . . . N, j=1 . . . M (23a).

More specifically, the confusion matrix is as follows:

$$M = [ \begin{matrix}p ( {T}_{D} / T ) & p ( {T}_{ND} / T ) \\ p ( {T}_{D} / {T}_{N} ) & p ( {T}_{ND} / {T}_{N} )\end{matrix} ]$$

It is assumed that at a given time instant, the target classification state of a target t is given by a probability distribution P={p(c₁),p(c₂)}, where p(cⱼ) is the probability that the correct class is cⱼ.

Equivalently P={p(T), p(T_{N})}, where p(T_{N})=1−p(T).

The current target search entropy for cell a is then as follows:

$$\begin{matrix}{H}_{a} ( S ) = - {\sum }_{j = 1}^{M} p ( {c}_{j} ) {log}_{2} p ( {c}_{j} ) \\ = - p ( T ) {log}_{2} p ( T ) - ( 1 - p ( T ) ) {log}_{2} ( 1 - p ( T ) ) .\end{matrix} \qquad ( 24 a )$$

In the same manner, the performance requirements on search accuracy can be transformed just as was done for the classification entropy using the three embodiments described above. The desired entropy state is denoted as H_{a,d}(S).

The desired information need N(S) of a cell a is the difference between the current and desired entropy expressed as follows:

Nₐ(S)=Hₐ(S)−H_{a,d}(S) (25a).

In general, the lower bound of entropy is used as a measure of the desired entropy. Thus, each cell's information need can be determined based on its current and desired classification state. Cells with high Nₐ values are in more urgent need of search measurements. Additionally, cell priority P (provided as supplemental information) can be lumped into the search information need. Thus, search information need can be expressed as follows:

Nₐ(S)=Pₐ(Hₐ(S)−H_{a,d}(S)) (26a).

Equation (26a) is a measure of search information need of a cell (sector). If it is assumed that there are A cells in within a particular sector, then the need of Nₐ(S)∀a=1, . . . , A of each cell can be computed using Equation (26a).

Previously in section (A), embodiments have been described for computing track kinematic need (i.e. Equation (6a), track classification need (i.e. Equation (22a)) and cell search information need (i.e. Equation (26a)). It will be noted that these embodiments use similar forms of equations in that they are all based on the priority (track/cell) and their current and desired information states. In the following description of section (B), the method is described for determining the utility of a sensor in terms of improving the current information state (information gain).

(B) Information Gain The information gain of a sensor is defined as the difference between the current information state and the predicted information state if the sensor were to make that measurement. The following describes methods for computing information gain for the kinematic, classification and search measurement modes in response to the state and knowledge base inputs shown in FIG. 2.

Kinematic information gain-Module 100-8a If the state covariance matrix of a track t after a measurement by a sensor k as P_{k,after,} then the information gain due to the measurement is the difference between the before and after entropies which can be expressed as follows:

$${I}_{t , k} ( X ) = {H}_{before} ( X ) - {H}_{k , after} ( X ) = {log}_{2} ( \frac{\vert {P}_{before} \vert}{\vert {P}_{k , after} \vert} ) . \qquad ( 27 b )$$

The above equation gives a predicted measure of the utility of the sensor k for track t. It will be noted that the gain is computed before the sensor actually makes the measurement. Hence, it is a predictive computation. All sensors k with a positive value from Equation (27b) become options for satisfying the information need for track t. From this, a list of all such sensors for all tracks can be then computed. This list can optionally then is provided to an operator as discussed herein.

Classification information gain-Module 100-8b Similarly, the classification gain can be computed. The current classification entropy of a target is given by Equation (8a). The conditional classification entropy of the target given an attribute aᵢ by sensor k is as follows:

$${H}_{k} ( C / {a}_{i} ) = {\sum }_{j = 1}^{M} {p}_{k} ( {c}_{j} / {a}_{i} ) {log}_{2} {p}_{k} ( {c}_{j} / {a}_{i} ) . \qquad ( 28 b )$$

where pₖ(cⱼ/aᵢ) is the conditional probability of class cⱼ given the attribute measured is aᵢ and is calculated as follows using Bayes theorem implemented by a Bayesian network:

$$\begin{matrix}{p}_{k} ( {c}_{j} / {a}_{i} ) = \frac{{p}_{k} ( {a}_{i} / {c}_{j} ) p ( {c}_{j} )}{{p}_{k} ( {a}_{i} )} . & ( 29 b ) \\ {p}_{k} ( {a}_{i} ) = {\sum }_{j = 1}^{M} {p}_{k} ( {a}_{i} / {c}_{j} ) p ( {c}_{j} ) . & ( 30 b )\end{matrix}$$

The classification entropy conditioned on measurement by sensor k is then a weighted sum of classification entropies conditioned on each of the possible measured attributes by sensor k and is given by the following equations:

$$\begin{matrix}{H}_{k} ( C / measurement by sensor k ) = {\sum }_{i = 1}^{N} {p}_{k} ( {a}_{i} ) {H}_{k} ( C / {a}_{i} ) . \\ Or & ( 31 b ) \\ {H}_{k} ( C / measurement by sensor k ) = {\sum }_{i = 1}^{N} {\sum }_{j = 1}^{M} {p}_{k} ( {a}_{i} ) {p}_{k} ( {c}_{j} / {a}_{i} ) {log}_{2} {p}_{k} ( {c}_{j} / {a}_{i} ) . & ( 32 b )\end{matrix}$$

where pₖ(cⱼ/aᵢ) is given by Equation (29b).
The information gain in classification for track t due the sensor k measurement is:

I_{t,k}(C)=Hₜ(C)−-H_{t,k}(C/measurement by sensor k) (33b).

Again, the subscript t has been added to the above terms to denote track t. All sensors k with a positive value from Equation (33b) become options for satisfying the information need for track t. A list of such sensors for all tracks can be then computed.

Search information gain-Module 100-8c For the search case, the information gain for a cell can be computed in exactly the same way as in the classification case for a track with the appropriate classification probabilities replaced by the search case probabilities. The information gain in search for a cell a due to sensor k measurement is defined as follows:

I_{a,k}(S)=Hₐ(S)−H_{a,k}(S/measurement by sensor k) (34b).

where Hₖ(S/measurement by sensor

$${H}_{k} ( S / measurement by sensor k ) = {\sum }_{i = 1}^{N} {p}_{k} ( {a}_{i} ) {p}_{k} ( {c}_{j} / {a}_{i} ) {log}_{2} {p}_{k} ( {c}_{j} / {a}_{i} ) . \qquad ( 35 b )$$

All sensors k with a positive value from Equation (34b) become options for satisfying the information need for cell a. A list of such sensors for all cells can be then computed.

Section (B) has presented approaches (embodiments) to computing track kinematic gain (Equation (27b), track classification gain (for any sensor) (Equation (33b) and cell search gain (Equation 34b). It will be noted that the forms of all the equations are similar in that they are based on the current and predicted information states. The next section (C) describes the closed loop sensor control system of the present invention whose implementation is based on the information need(s) computed in Section (A) and the information gain(s) computed in Section (B).

(C) Closed Loop Sensor Control The concept behind open-loop information based sensor management is to select sensors that maximize information gain I_{t,k} or I_{a,k}. By contrast, the concept of closed-loop sensor control is to manage sensors to optimally address the need of all tracks. Thus, closed-loop management of the system of FIG. 1 is designed to take both need and sensor information gains into account.

Sensor Management Module 100-2 By way of example, in the system of the preferred embodiment, it is assumed that there are T tracks and K sensors being utilized. The kinematic and classification need Nₜ ∀t=1, . . . ,T of each track is computed using Equations (7a) and (22). Also, the kinematic and classification information gain Iₜₖ ∀t=1, . . . ,T, ∀k=1, . . . ,K for each track, sensor pair is computed using Equations (27b) and (33b) to form an information gain matrix of size T×K. Then, the system directly compares the kinematic and classification quantities for pairing sensors and tracks as discussed herein. The method for scaling these quantities for such pairing is later discussed herein. If sensor k is assigned to track t for the next measurement cycle, this is denoted as aₜₖ=1, otherwise aₜₖ=0. The system goal is to determine the aₜₖ that achieves the best overall information objective. Generally speaking, the goal is to select tracks with high information need (N) values and pair them with sensors with high information gain (I) values. By way of example, two embodiments for implementing such pairing by the closed-loop sensor control system component 100-2 are described herein. Each embodiment takes into account both information need and gain for achieving optimal control. These embodiments determine the pairing of sensors with tracks by combining the benefits (gains) for doing such pairing. For example, a single sensor might be able to provide or measure both kinematic and ID information. In that case, both kinematic and ID information gains are added together and the total gain is used for pairing or assigning the sensor with a particular track.

Greedy Module 100-2c Embodiment Method In the greedy embodiment, the method for sensor management is as follows:

1. Start with all the values aₜₖ=0.

2. Select track t with the highest Nₜ value. Pair it with the sensor k that has the highest Iₜₖ value for this track t, i.e. set aₜₖ=1. After pairing, update the need of this track as (Nₜ−Iₜₖ). If it is assumed that a sensor can only do one task at a time, then update the information gain value of this sensor as Iₜₖ=0.

3. Repeat step 2 until there are no sensors with a positive Iₜₖ value or tracks with positive Nₜ values. A negative Nₜ value for a track means that the track performance objective or goal has been reached. A zero Iₜₖ value for a sensor means that this sensor is not available for any measurement.

The resulting aₜₖ's are the final sensor-track pairings.

Optimization Module100-2e Embodiment Method In a global optimization method, sensor management operates to achieve the following:

$$\begin{matrix}Maximize {\sum }_{i = 1}^{T} {\sum }_{j = 1}^{K} {a}_{tk} ( {I}_{tk} * {N}_{t} ) subject to . & ( 36 c ) \\ {\sum }_{k = 1}^{K} {a}_{tk} \leq 1 ∀ t = 1 , … , T . & ( 37 c ) \\ {\sum }_{t = 1}^{T} {a}_{tk} \leq 1 ∀ k = 1 , … , K . & ( 38 c )\end{matrix}$$

The first constraint is that each track must be paired with a single sensor only. If a sensor can handle multiple simultaneous measurements, the right hand side of the inequality will reflect that. The second constraint is the tasking capacity of each sensor. This is a constrained linear integer optimization problem. The objective function in Equation (34b) is just one embodiment of the function that can be used herein. Other functions such as weighted combination of gain and need or other nonlinear cost function can just as easily be used herein. The constraints in Equations (25a) and (36b) are some examples of such constraints.

It will be noted that the above described two methods (greedy and optimization) are just two embodiments that can be used to implement the sensor manager module of the present invention. Other variants of the objective function and resource allocation/optimization methods can be just as easily used. The described optimization method shows a one step look-ahead control policy. Multi-step look-ahead control policies can also be employed as well based on the need and gain computations described in the previous sections. Optimal control for the search closed-loop control can be similarly formulated except that now it is a cell-based as opposed to a track-based method.

Scaling Module 100-2a Method As described above, the search and ID information need are based on Shannon entropy, while the kinematic need is based on differential entropy. The entropies are qualitatively similar but cannot be directly compared to determine which need is higher. The following describes a mechanism for comparing the two types of entropies to determine what actions to take when both types of needs are present.

The highest entropy for a classification case occurs when all tracks are equi-probable. This entropy will be denoted as Hₘₐₓ(C). Similar entropy can be defined for the kinematic case in terms of a covariance matrix. It will be noted that in theory this can be infinite (i.e. corresponds to infinite error in state estimation), but will have some finite valued errors in practice. It was chosen to use the initial covariance matrix contained in the Kalman filter network. The corresponding entropy will be denoted as Hₘₐₓ(X). The ratio of these two types of entropies will be denoted as R where R is Hₘₐₓ(C)/Hₘₐₓ(X). By scaling all kinematic (differential) entropies and related quantities by R, now these entropies can be compared with ID quantities. Once the need and gain equations for kinematic information given by Equations (9a) and (29b) have been scaled, this now gives all need and gain terms in the same reference system. This now allows solving sensor management for ID and kinematic case as a single problem. By adding the search as another sub case in the same framework further complicates the problem. However, in the same manner just described for the kinematic and classification case, a relative scaling also can be determined for the search case.

The result is that now all information needs and gains have been brought into a single common quantitative framework. Now, module 100-2 is able to compare, add, etc. these quantities etc. to determine the joint information needs and gains. By way of example, consider a sensor mode footprint that covers nine search cells and six of the cells contain targets (i.e. ground-truth, but not known a priori). It will be assumed that four targets have already been detected via search and are now in track at varying kinematic and ID accuracies. By using the above measurements, the total information need of this footprint area can be determined. Similarly, given the sensor mode and its capabilities (i.e. to search, track and/or classify), the total information gain can now be predicted should this sensor be used to make a measurement.

Similar computations can be made for other sensor mode and look angles. This provides a quantitative way of comparing the value of different sensor modes and look angles in terms of achieving the desired objectives. By managing the sensors using this information in a sequential manner, closed-loop sensor control can be established. It will be appreciated that the use of the scaling mechanism described above is one method of bring all quantities in the same framework. Other embodiments or mechanisms can also be used to provide the same framework such as a non-linear scaling mechanism.

Display Option Module 100-2b As indicated in FIG. 2, this module receives the scaled kinematic need and gain outputs, the classification and search need outputs, and the ID and search gain outputs. In addition to being passed onto modules 100-2c and 2d for automatic sensor/track pairing, they are also applied to module 100-2b which provides the lists of needs tasks and sensor options shown in FIG. 1b. This involves the use of a conventional sorting function which sorts in numerical order the need and gain values (e.g. numerical sorting).

### Description of Operation

With reference to the flow charts of FIG. 3a and 3b, the operation of the closed-loop sensor control system of FIG. 1 will now be described.

The previous sections (A), (B), and (C) described the functional modules of the preferred embodiment of the present invention for carrying out closed-loop sensor control. The flow chart of FIG. 3a illustrates the method of the preferred embodiment of the present invention for carrying out surveillance and tracking operations.

### FIG. 3a

As shown in block 01, the system 100 receives as inputs, measurement inputs from a plurality of sensors (i.e. sensors S1 through Sn) which are applied as inputs to the fusion module 100-12. The sensors are generally of different types and each sensor provides information about the target type. As discussed, the sensors classify targets based on measured attributes and by way of example; it is assumed that only one attribute is measurable by one sensor at a single sampling time or measurement cycle of operation.

As indicated in blocks 02 and 03, the inputs are applied to the kinematic information need module 100-4a 2and kinematic gain module 100-8a of FIG. 2 along with the performance requirements inputs. These modules compute the kinematic need (discrete and differential) and classification need entropy outputs in accordance with Equations (1a) through (22a) of section (A) and Equations (27b) through (33b) of section (B) respectively. Also, the modules 100-4c and 100-8c compute the search information need and search information gain entropy outputs in accordance with Equations (23a) through ((26a) of section (A) and Equations (34b) through (35b) of section (B) respectively. Lastly, the scaling module(s) 100-2a scales the kinematic and search information needs and kinematic and search information gains output entropies in accordance with established ratios for providing all need and gain entropy outputs into a single common quantitative framework.

As shown in FIG. 3a, the outputs from blocks 02 and 03 are applied as inputs to block 04 which determine how to control the sensors to optimally meet the needs of all tracks and all cell sensors from the positive needs and gains entropy outputs computed in blocks 02 and 03. As indicated in block 04, based on suggested pairing of tracks and sensors from step 4a, the sensors are assigned by sensor manager module 100-2 which also provides signals defining the tasks that the sensors are to perform (e.g. the kind of operating mode) as indicated in block C of FIG. 1b. The measurements inputs from sensors S1 through Sn are used by fusion module 100-12 to update the track and cell states which created a new system state (i.e. an updated picture of the world). Additionally, the module 100-2 initiates tracks for all search cells that have reached the desired search detection accuracy. As soon as a cell has been classified as having a track, a Kalman tracker and Bayesian classifier are started for that track.

As shown in FIG. 3a, the operations of blocks 02 and 03 are repeated until all performance goals have been achieved as determined in block 05. Performance goals are achieved when the need of tracks or cells become negative (i.e. the current information state exceeds the desired information state. See Equations 6a and 21a need equations for kinematic and classification needs respectively. See Equation 26a for search need case. In each of these equations, when Nₜ<0, the corresponding performance goal has been achieved.

### FIG. 3b

FIG. 3b illustrates in greater detail, the operations of block 04 in carrying out steps 4a through 4d. As indicated, system 100 brings all information needs and gains into a single common quantitative framework expressed in terms of entropy values. At, this point, each of the need and gains entropy values are compared and or added for determining joint information needs and gains. Next, as indicated, the system 100 performs one of the pairing methods in step 3 utilizing one of the modules 100-2c or 100-2d of FIG. 2. By way of example, it is assumed that the pairing method is performed by greedy module 100-2c.

As shown in FIG. 3b, first, the system 100 sets all attribute measurements of all sensors for all tracks to zero (i.e. aₜₖ=0). Next, system 100 selects the track with the highest kinematic and classification Need (Nₜ) value and pairs it with the sensor that has the highest kinematic and classification gain (Iₜₖ) value for that track (i.e. aₜₖ=0). After pairing of the selected track with this sensor, the system 100 updates the need of the selected track as given by (Nₜ−Iₜₖ). If the particular sensor has the capacity of only performing one task at a time, the system 100 updates the information gain of this sensor as Iₜₖ=0.

The system 100 repeats the operations of steps 3a1 through 3a4 until there are no sensors with positive Iₜₖ values for kinematic and classification gain as computed using Equations (27) and (35) respectively or tracks with positive Nₜ values for kinematic and classification Need as computed using Equations (5) and (21) respectively. The system produces a list of the resulting aₜₖ's corresponding to the final track pairings for providing more attribute data to perform sufficient classification (ID).

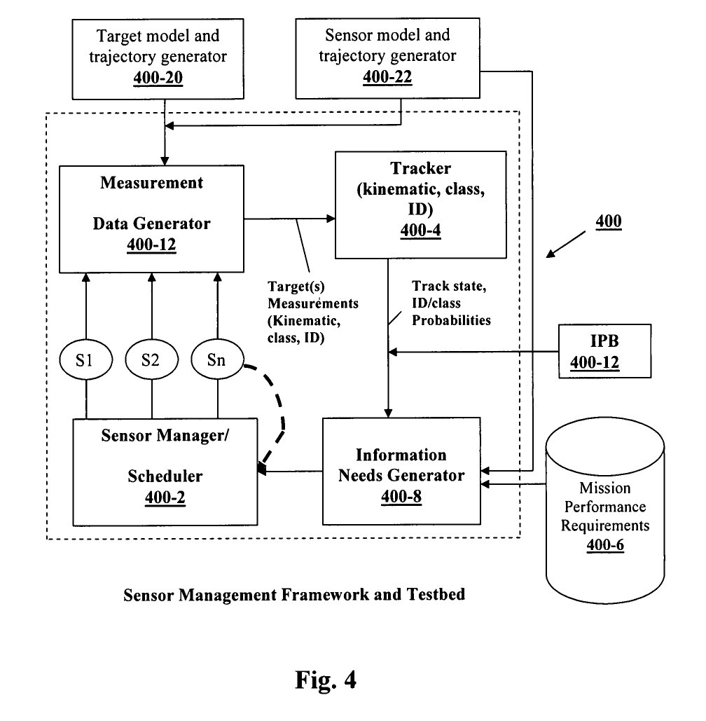

Simulation Results The following description in connection with FIGS. 4, 5, 6a and 6b is included to further understand the usefulness and advantages of the system of the present invention in providing sensor closed-loop control in conjunction with a specific simulation scenario. This material should not be construed in any way to limit the system or method of the present invention.

Combined example/simulations The simulation testbed tool was used to demonstrate the effectiveness of closed-loop sensor control system of the present invention in ground target tracking applications. The testbed tool (simulation model) was developed using the matrix-based Matlab programming language. This language was selected because of its built-in graphics capability and the inherent programming structure that can later be converted to the C programming language or a simulation language for compilation and faster execution as well as its portability. The testbed tool was designed to generate problem scenarios with target models, sensor models, trackers, classifiers and performance goals. This provided the ability to plug in different algorithms and methods and compare performance and carry out sensitivity analysis to Key Performance Parameters (KPP).

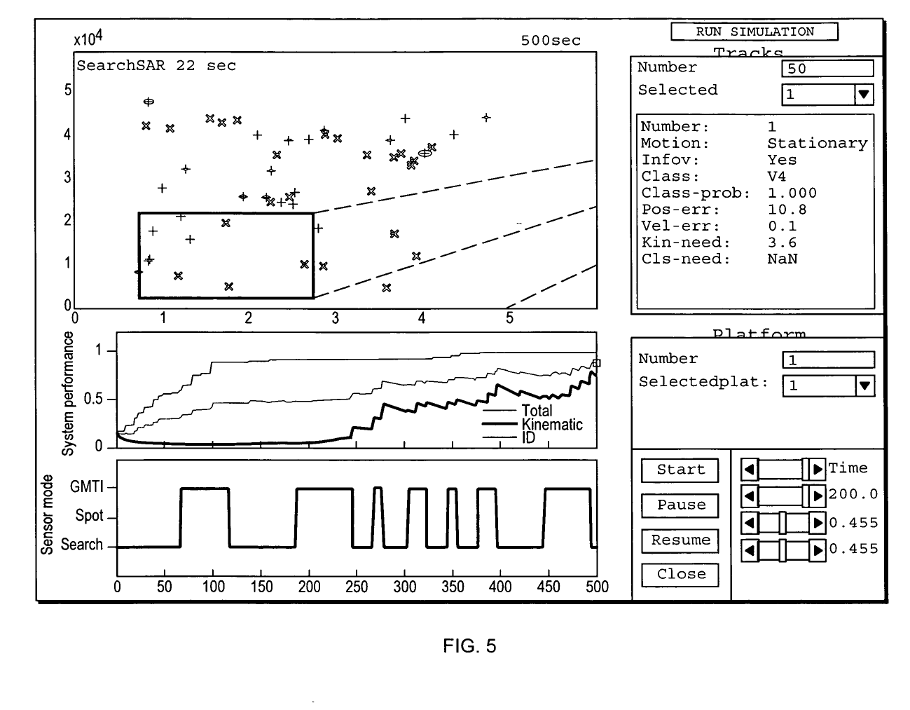

In greater detail, the simulation of the closed-loop control system 100 was carried out using the testbed simulation tool components shown in FIG. 4. Briefly, as shown, the closed-loop control system 100 was simulated using components 400-2 through 400-12 which functionally correspond to modules 100-2 through 100-12. Performance criteria information and intelligence preparation of battle field (IPB) knowledge base information (e.g. identifies an area of interest-surveillance area such as represented graphically in the top area of the display in FIG. 5) were provided by components 400-6 and 400-12. Current state information was provided by generator components 400-20 and 400-22. As shown in the snapshot of the testbed simulation tool and environment of FIG. 5, the testbed tool was run from a Graphic User Interface (GUI) with fixed and controllable parameters, start/pause/stop capabilities, display of targets and sensors, display of errors and performance statistics and display of current vs. desired performance goals.

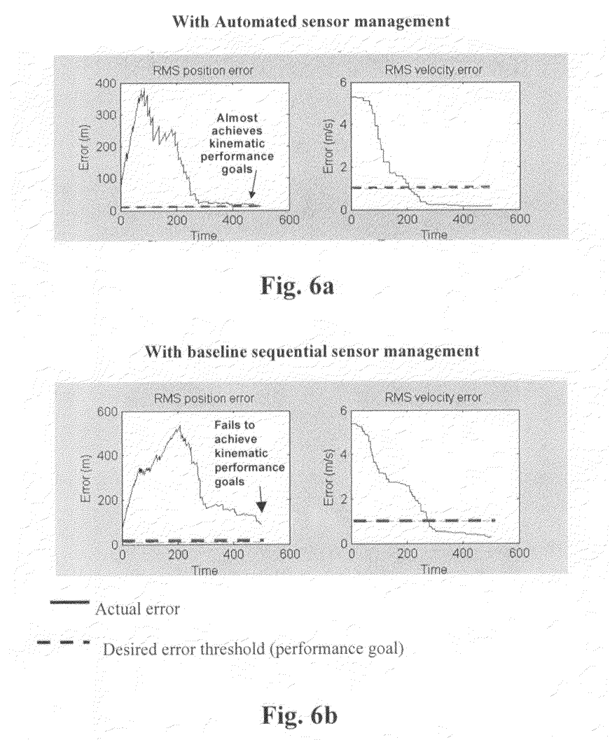

Typical results of one problem scenario are shown in FIGS. 6a and 6b. In this scenario, fifty (50) targets were simulated with a mix of moving and stationary targets in a 50 km×50 km Area-of-Interest (AOI) that needed to be detected, tracked and classified by one sensor platform moving along a fixed trajectory. The starting locations of targets were generated randomly in the AOI. Moving targets were of constant velocity and non-maneuvering with radial velocities in the range of 5-30 km/h (2-8 m/sec). The target class was defined as being one of 6 different classes: {V1, V2, V3, V4, V5, V6}, where V1-V5 are military target class and V6 is noncombatant class.

Each target class emitted a signal (detectable by SIGINT) once very D min (nominal value of D was 10 mins). Platform altitude and velocity was set to be constant at 20 km and 250 m/s with standoff to AOI being nominally 50 km.

The platform had 4 sensor/mode options available: Search SAR, Spot SAR, GMTI, and SIGINT. Search SAR, Spot SAR and SIGINT provided class information (V1-V6) with varying accuracies. In reality, Spot SAR and SIGINT provide specific type information within class—and thus the class as well. To simplify the problem, class information only was assumed for this operation. Search, Spot and GMTI could not operate simultaneously. The elapsed time to change between SAR and GMTI modes was zero. SIGINT was “on” all the time and had totally separate processing/comm./etc. from the radar modes and could be done concurrently. The sensor manager 400-2 of FIG. 4 was able to control the following parameters: sensor mode (Search SAR, Spot SAR, GMTI), sensor mode parameters (center coordinates of patch, coverage area size) and the measurement start/end time. Here, the coverage area size for each mode was fixed (see Table 1 below) and the measurement end time was dictated by the time taken to measure/process the data onboard. An ad-hoc calculation was done based on range, dwell time, inter-scene gap time, etc. The details and actual numbers are not relevant since the purpose was to show the control of the sensor platform to achieve better performance via automatic management compared to a manual managed case (where platform makes measurement based on operator control).

TABLE I

| | | | Area | Target |
|---|---|---|---|---|
| | Data | Angular | Coverage | Loc/Vel |
| Mode | Collected | Limits | (2) | Accuracy |
| Search | 3 ft. SAR | +45 to −45 | 20 km by | 10 m CEP |
| SAR | imagery | squint | 20 km | |
| | | angle | square | |
| Spot SAR | 1 ft. SAR | +45 to −45 | 5 km by | 5 m CEP |
| | imagery | squint | 5 km | |
| | | angle | square | |
| GMTI | Moving | +45 to −45 | 10 km by | 5 m CEP |
| | target | squint | 10 km | +/−2 m/s |
| | location, | angle | square | |
| | velocity | | | |
| SIGINT | Target ID, | +90 to −90 | Entire | 1 km CEP |
| | coarse | squint | AOI | |
| | location | angle | | |

The class measurement accuracy notion is shown in the picture below. For this example, if the true class is V1, then V1 is the correct class and V2-V6 are incorrect classes. The corresponding sensor output declaration probabilities are as shown in the picture.

The probabilities of correct and incorrect class declaration for the different modes were as follows (i.e. GMTI does not provide class information):

| | | | |
|---|---|---|---|
| SAR Search | p1 = 0.7 | p2 = 0.04 | p3 = 0.1 |
| SAR Spot | p1 = 0.9 | p2 = 0.01 | p3 = 0.05 |
| SIGINT | p1 = 0.8 | p2 = 0.02 | p3 = 0.1 |

The desired overall system performance requirements in this case were: Target location accuracy=3 m CEP, Target velocity accuracy=±1 m/s, and P (correct target class)=0.90. The simulation started by generating the scenario and was then allowed to run for 500 sec. As the targets moved in the AOI and the sensor platform flew overhead, the simulated system of the present invention operated to control the sensor platform measurements so as to achieve the desired performance goals. Typical results of the problem scenario are shown in FIGS. 6a and 6b. As discussed, in this scenario, there were 50 targets (mix of moving and stationary) in a 50 km×50 km Area of Interest. For this problem size and given sensor resources, the simulated system incorporating the principles of the present invention was able to achieve the desired performance in 500 sec shown in FIG. 6a.

A baseline approach was used for comparison that approximately mirrored a human operator's manual control strategy. This baseline algorithm worked in either a random or sequential measurement mode. The baseline mode was made “intelligent” so as not to give the system of the present invention any undue advantage when comparing both. Thus, if no tracks were present in an area which otherwise would have been covered by a mode in the random baseline approach, this area was skipped so that sensor resources were not wasted. Likewise, the modes were applied intelligently, for example, a SAR mode was not applied to an area that contained only moving targets. The purpose was to have the “baseline” algorithm approximate operator type of manual decision-making. For this problem scenario, the sequential baseline algorithm was run and the results compared. As seen in FIG. 6b, the baseline algorithm was unable to come close to the desired performance requirements in the same time (500 sec) as compared to those of FIG. 6a.

From the above description and simulation results, it is seen how the system of the present invention utilizes the concept of need for search and classification (ID) based on desired goals. It utilizes a single metric and framework to combine and compare all of the different needs (i.e. search, kinematic, ID). The system also uses the same metric to identify what actions will best satisfy such needs. Based on these needs, the system generates a list of prioritized tasks/actions to which the system automatically responds in a dynamic closed-loop manner. Optionally, the list of prioritized tasks is provided to an operator for action such as indicated in FIG. 1b. Further, the system of the present invention combines all of the above and controls the actions to satisfy the needs of the system in a dynamic closed-loop manner.

### GLOSSARY OF TERMS

1. A track is a time sequence of Kinematic measurements (position/velocity, class/ID (probability), search estimates) for an object (target).
2. A sensor is used to measure characteristics of a target, including kinematic measurements, class measurements and search measurements.
3. A Kinematic Measurement is a measurement regarding some kinematic characteristic of a target, such as position and/or velocity. Kinematic measurements are typically generated through the use of a sensor such as a radar generating radar signals.
4. A Class/Identification Measurement is a measurement directly about the class/type of target or indirect measurement about the class/type in the form of features. A class is information about the object to be identified (e.g. whether the object is a tank or truck). A feature, generally, is a frequency of a signal from the object (represents a characteristic or attribute). The latter generally assumes that some relationship between features and the class (type) are available in the form of uncertainty rules.
5. Multi-sensor data fusion-(sensor fusion) is the combining of sensory data or data derived from sensory data form disparate sources (e.g. sensors (radar) such that the resulting information is in some sense better (e.g. more accurate, more complete or more dependable) that would be possible when these sources were used individually.
6. A Kalman filter is an efficient recursive filter which estimates the state of a dynamic system from a series of incomplete and noisy measurements. An example of an application would be to provide accurate continuously-updated information about the position and velocity of an object given only a sequence of observations about its position, each of which includes some error. The Kalman filter is recursive which means that only the estimated state from the previous time step and the current measurement are needed to compute the estimate for the current state
7. A tracker is a component of a radar system that aggregates individual radar observations into tracks. It is particularly useful when the radar system is reporting data from several different targets. A tracker operates by comparing the incoming data from the radar sensor with earlier data and determining which new observations are consistent with existing tracks. A typical tracker employs a Kalman filter or a similar device to make the comparison. Depending on the particular data produced by the sensor, the tracker may use a sequence of the target's reported locations to deduce the target's course and speed, or it may use the reported course and speed to aid in tracking.
8. Synthetic aperture radar (SAR) is a form of radar in which sophisticated post-processing of radar data is used to produce a very narrow effective beam and allows broad area imaging at high resolutions.
9. Search SAR mode is generally defined as a mode in which the radar/tracking system is capable of providing low accuracy information for stationary target information over a broad area.
10. Spot SAR mode is generally defined as a mode in which the radar/tracking system is capable of providing more accurate information for stationary targets but over a smaller area than Search SAR. The spot SAR mode provides very high-resolution images of fixed targets from an airborne platform, while the Search SAR mode provides wide-area fixed target imagery.
11. GMTI (Ground Moving Target Indicator) mode is generally defined as a mode in which the radar/tracking system is capable of providing target location and velocity profiles;
12. SIGINT mode is generally defined as standing for SIGnals INTelligence, which is intelligence-gathering by interception of signals, whether by radio interception or other means.
13. A knowledge base is a special kind of database for knowledge management. It provides the means for the computerized collection, organization, and retrieval of knowledge in the present system in the form of sensor modes and capabilities, the type of tracker being used and type of classifier. It would also contain track files, data quality reports, confidence reports with attribute information. As stated, the knowledge base contains information about sensors, their capabilities, and operational modes. For example, it may list that sensor1 can operate in SearchSAR and SpotSAR modes and list the measurement accuracies of these operational modes. It may also list the maximum FOV of the sensor, the maximum speed and turn rate of the sensor platform, etc. It may also list the type of kinematic tracker (e.g., standard Kalman filter) and ID engine (e.g., standard Bayesian classifier) to be used in the system. The information contained in the knowledge base is used to determine the various sensor options and information gain values for a track or cell.
14. Performance Requirements are the desired goals to be achieved by the system. The desired kinematic performance goal state is usually specified as desired kinematic track accuracy. For example, the desired tracking accuracy of an incoming target in various phases may be as follows:

| | |
|---|---|
| Tracking accuracy - Maintenance | 20 m |
| Tracking accuracy - Mid-course | 10 m |
| Tracking accuracy - Terminal | 2 m |

The above numbers represent the rms tracking accuracy value in meters.

The system translates the desired goal “kinematic” accuracy into a desired goal “information” state. One interpretation used in this embodiment is to translate desired goal “kinematic” accuracy into a desired goal covariance entropy value.

### Examples:

Goal mid-course tracking accuracy=10 m
Current kinematic accuracy (square root of variance) of Track 1=75 m
Information Needs of Track 1=Differential entropy between current and goal states=3.165.
15. Shannon entropy or information entropy is a measure of the uncertainty associated with a discrete random variable. It is a measure of the average information content the recipient is missing when they do not know the value of the random variable. In information theory, self-information is a measure of the information content associated with the outcome of a discrete random variable. It is expressed in the unit of information: the bit. By definition, the amount of self-information contained in a probabilistic event depends only on the probability p of that event. More specifically: the smaller this probability is, the larger is the self-information associated with receiving information that the event indeed occurred.
16. Differential entropy (also referred to as continuous entropy) is a concept in information theory which tries to extend the idea of (Shannon) entropy, a measure of average surprisal of a random variable, to continuous probability.
17. A covariance matrix in statistics and probability theory is a matrix of covariances between elements of a vector. It is the natural generalization to higher dimensions of the concept of the variance of a scalar-valued random variable. Intuitively, covariance is the measure of how much two random variables vary together (as distinct from variance, which measures how much a single variable varies). If the two variables are independent, then their covariance is zero.
18. A confusion matrix is a visualization tool typically used in supervised learning (machine learning technique for creating a function from training data). In unsupervised learning, it is typically called a matching matrix. Each column of the matrix represents the instances in a predicted class, while each row represents the instances in an actual class. One benefit of a confusion matrix is that it is easy to see if the system is confusing two classes (i.e. commonly mislabelling one as an other). Also, unsupervised learning is a method of machine learning where a model is fit to observations. It is distinguished from supervised learning by the fact that there is no a priori output. In unsupervised learning, a data set of input objects is gathered. Unsupervised learning then typically treats input objects as a set of random variables. A joint density model is then built for the data set. Unsupervised learning can be used in conjunction with Bayesian inference to produce conditional probabilities (i.e. supervised learning) for any of the random variables given the others.
19. A Bayesian engine or Bayes estimator in decision theory and estimation theory is an estimator or decision rule that maximizes the posterior expected value of a utility function or minimizes the posterior expected value of a loss function. Specifically, suppose an unknown parameter θ is known to have a prior distribution Π. Let δ be an estimator of θ (based on some measurements), and let R(θ,δ) be a risk function, such as the mean squared error. The Bayes risk of δ is defined as E_{Π}{R(θ,δ)}, where the expectation is taken over the probability distribution of θ. An estimator δ is said to be a Bayes estimator if it minimizes the Bayes risk among all estimators.
20. A geographical state vector specifies the position and velocity of an object in space. There are state vectors for both kinematic and classification states for kinematic case, a simple embodiment is position and velocity information. For classification, a simple embodiment would be a probability vector comprising of probabilities of all possible class of that target, (e.g. If a target can possible be one of class C1, C2 of C3, then a class state vector could be [0.9 0.07 0.03] indicating probabilities of C1, C2 and C3.
21. An attribute is an entity that define a a property or characteristic of an object, element, or file.
22. A Monte Carlo run is used where there are variabilities in noise, sensor measurements, etc. and where a large number of runs of the algorithm are carried out and plot the statistical quantities/results corresponding to these runs.
23. Global optimization deals with the optimization (minimize or maximize a real function by systematically choosing the values of real or integer variables from within an allowed set) of a function or a set of functions to some criteria.
24. Data fusion is the combining of sensory data or data derived from sensory data from disparate sources such that the resulting information is in some sense better than would be possible when these sources were used individually. The term “better” in that case can mean more accurate, more complete, or more dependable, or refer to the result of an emerging view, such as stereoscopic vision (calculation of depth information by combining two-dimensional images from two cameras at slightly different viewpoints). The data sources for a fusion process are not specified to originate from identical sensors. One can distinguish direct fusion, indirect fusion and fusion of the outputs of the former two. Direct fusion is the fusion of sensor data from a set of heterogeneous or homogeneous sensors, soft sensors, and history values of sensor data, while indirect fusion uses information sources like a priori knowledge about the environment and human input. Sensor fusion is also known as (multi-sensor) data fusion and is a subset of information fusion.

While the invention has been shown and described with reference to specific embodiments, it should be understood by those skilled in the art that various changes in form and detail may be made therein without departing from the spirit and scope of the invention as defined by the following claims.

What is claimed is:

1. A method for providing closed loop management control of multiple sensors which establish tracks for targets, each sensor having a capability of operating in a number of modes, the method comprising the steps of:
(a) receiving kinematic, classification, and search measurements regarding the targets from the multiple sensors during a measurement cycle;
(b) receiving current track state kinematic, classification and search inputs from a fusion module which receives the inputs of step (a) and performance requirements inputs from a performance data file in addition to knowledge base inputs;
(c) computing kinematic, classification and search needs and gains from the state inputs and performance requirements and knowledge base inputs to produce a corresponding number of entropy outputs;
(d) scaling the kinematic need and gain entropy outputs relative to the classification and search entropy outputs so as to provide a common reference system for making entropy comparisons;
(e) combining the scaled need and gain outputs from step (c) and needs and gains from step (b) as required for determining joint information needs and gains for each track;
(f) pairing each track with one of the multiple sensors according to the results of step (d); and,
(g) repeating steps (a) through (f) until all of the goals defined by the performance requirements for performing sufficient target classification has been optimally achieved.

2. The method of claim 1 further comprising the step of
assigning each of the multiple sensors and a respective one of the sensor modes for making the appropriate measurements during a next measurement cycle.

3. The method of claim 2 further comprising the step of
after step (g), updating the states of each track and each sensor cell by the fusion module using the measurements received from the sensors to determine a new system state.

4. The method of claim 3 wherein the sensors classify targets based on measured attributes and only one attribute (a) is measurable by one sensor at a single measurement cycle, and the method further including the step of
when a sensor is assigned to a track for the next measurement cycle, this is denoted by setting the value aₜₖ=1, otherwise set aₜₖ=0 wherein k and t designate the sensor and track respectively.

5. The method of claim 3 wherein sensors performing a search cover an area of interest (AOI) containing a plurality of search cells and the method further comprises the step of
initiating tracks for all search cells that have reached a desired search detection accuracy as established by the performance requirement inputs.

6. The method of claim 1 wherein step (b) further includes the step of
computing the kinematic needs for each track using a Kalman filter for kinematic tracking operations wherein P_{before} denotes the current state covariance matrix and P_{D} the desired covariance matrix as specified by the performance requirements defined in terms of tracking accuracy values, Nₜ represents kinematic information need of a track t, X represents a continuous random variable X and Pₜ represents the track priority, the kinematic needs being computed according to the following expression:
$${N}_{t} ( X ) = {P}_{t} {log}_{2} ( \frac{\vert {P}_{before} \vert}{\vert {P}_{d} \vert} )$$
wherein the desired kinematic information need Nₜ being positive as long as the desired covariance has not yet been achieved and a high positive value of Nₜ indicating that the track t needs kinematic sensor measurements urgently.

7. The method of claim 1 wherein step (b) further includes the step of:
computing classification needs for each track according to the following expression wherein it is assumed that sensors classify targets based measured attributes and only one attribute is measurable by one sensor at a single sampling time:
Nₜ(C)=Hₜ(C)−H_{t,d}(C)
wherein Nₜ(C) represents the current target classification entropy, Hₜ(C) represents the current classification of a track and H_{t,d}(C) represents the desired target classification entropy of a track wherein a track with high positive value of Nₜ indicates that the track is in more urgent need of a classification or attribute measurement.

8. The method of claim 7 wherein the probability of correct classification P_{c} of a target is the same as the posterior probability of a class c1 with the highest probability as determined as by the method based on an upper and lower bound computed from the remaining classes.

9. The method of claim 7 wherein the probability of correct classification P_{c} of a target for a fully characterized system where a function corresponding to as receiver operating curve ROC that relates the probability of correct classification verses the posterior probability of declared classification P_{d} which is the probability of the class or classification with the highest probability is available, then the declared classification probability corresponding to P_{c} is computed using the function ROC.

10. The method of claim 7 wherein the probability of correct classification P_{c} of a target is computed as a measure of confidence wherein confidence is defined as a number in the range of 0-1 and is given as the ratio of the difference between the highest class probability and the second highest class probability to the highest probability.

11. The method of claim 1 wherein for a given search scenario with some current state step (b) further includes the step of computing the search needs of an area of interest (sector) which is divided into N cells wherein each cell contains at most one target based on desired goals defined by the performance inputs, the step of computing the search needs is carried out according to the following expression:
Nₐ(S)=Pₐ(Hₐ(S)−H_{a,d}(S))
wherein Nₐ(S) represents the desired search need of a cell a, Pa represents cell priority, Hₐ(S) represents current target search entropy for a cell and H_{ad}(S) represents the desired entropy state, cells with high Nₐ values being in more urgent need of search measurements.

12. The method of claim 1 wherein step (b) further includes the step of:
computing kinematic gain for each sensor according to the following expression:
$${I}_{t , k} ( X ) = {H}_{before} ( X ) - {H}_{k , after} ( X ) = {log}_{2} ( \frac{\vert {P}_{before} \vert}{\vert {P}_{k , after} \vert} )$$
wherein the expression defines the information gain of the sensor as the difference between the current information state and the predicted information state if the sensor were to make that measurement wherein I_{t,k}(X) represents the kinematic information gain, H_{before}(X) represents the before entropy value and H_{k,after} represents the after entropy value and wherein each sensor k having a positive value from the computed expression is an option for satisfying the information need for track t.

13. The method of claim 1 wherein the classification entropy conditioned on the measurement by sensor k is a weighted sum of the classification entropies conditioned on each of the possible measured attributes by sensor k and is given by step (b) which further includes the step of:
computing classification information gain for a sensor k according to the expression:
I_{t,k}(C)=Hₜ(C)−H_{t,k}(C/measurement by sensor k)
wherein I_{t,k}(C) represents the classification information gain of track t, Hₜ(C) represents the current classification information entropy value of track t, and H_{t,k} represents the classification information gain of track t measured by sensor k and wherein all sensors k with a positive value computed from the expression become options for satisfying the information need for track t.

14. The method of claim 1 wherein step (b) further includes the step of computing search gain of a cell a due to sensor k measurement according to the following expression:
I_{a,k}(S)=Hₐ(S)−H_{a,k}(S/measurement by sensor k)
wherein I_{a,k}(S) represents the search information gain of a cell, Hₐ(S) represents the current search information gain entropy value and H_{a,k}(S) represents the desired search information gain entropy value and wherein all sensors k with a positive value computed from the expression become options for satisfying the information need for cell a.

15. The method of claim 1 wherein the step (c) further includes the step of:
computing a ratio represented by R of the highest classification entropy output value Hₘₐₓ(C) and the highest kinematic entropy output value Hₘₐₓ(X) is given by the expression:
R=Hₘₐₓ(C)/Hₘₐₓ(X)
wherein all the kinematic (differential) need and gain entropy values are scaled by R for having all need and gain values defined in terms of the same metric reference system.

16. The method of claim 1 wherein step (e) further includes the steps of:
1. start with all the values aₜₖ=0;
2. select track t with the highest Nₜ value and pair it with sensor k that has the highest Iₜₖ value for this track, setting aₜₖ=1;
3. after completion of step 2, update the need of track t as (Nₜ-Iₜₖ) and when that sensor can only do one task at a time, then update the information gain value of this sensor as Iₜₖ=0;
4. repeat step 2 until there are no sensors with a positive Iₜₖ value or tracks with positive Nₜ values and
wherein a negative Nₜ value for a track means that the track performance goal has been reached and a zero Iₜₖ value for a sensor means that the sensor is not available for any measurement.

17. The method of claim 1 wherein step (e) performs a global optimization operation for determining the values of atk's that maximize the following expression:
$$Maximize {\sum }_{i = 1}^{T} {\sum }_{j = 1}^{K} {a}_{tk} ( {I}_{tk} * {N}_{t} ) subject to$$
$${\sum }_{k = 1}^{K} {a}_{tk} \leq 1 ∀ t = 1 , … , T$$
$${\sum }_{t = 1}^{T} {a}_{tk} \leq 1 ∀ k = 1 , … , K$$
with the constraint is that each track must be paired only with a single sensor in addition to constraints pertaining to sensor tasking capacity and handling of multiple measurements.

18. A system for providing closed loop management control of multiple sensors which establish tracks for targets, each sensor having a capability of operating in a number of modes, the system comprising:
(a) a plurality of compute modules, different ones of the modules of a first group of the compute modules being operative to receive current target/track kinematic, classification and search state inputs respectively and performance requirements inputs during a measurement cycle and different ones of the modules of a second group of compute modules being operative to receive the current target/track kinematic, classification and search state inputs respectively and knowledge base inputs;
(b) the first and second groups of compute modules in response to the states, performance and knowledge base inputs being operative to compute kinematic need and gain, classification need and gain and search need and gain entropy outputs respectively;
(c) the plurality of compute modules including a scaling module operatively coupled to predetermined ones of the first set of compute modules, the scaling module being operative to scale the kinematic need and gain entropy outputs relative to the classification and search entropy need and gain outputs so as to provide scaled need and gain entropy outputs having a common reference relative to the entropy outputs of the second and third sets of compute modules;
(d) the plurality of compute modules further including a planning and scheduling module operatively coupled to the scaling module, to different ones of the first and second groups compute modules for receiving scaled kinematic need and gain entropy outputs and need and gain entropy outputs from the first and second groups of compute modules respectively, the planning and scheduling module in response to the need and gain entropy outputs combining the entropy outputs representing the joint information needs and gains for each track and generating outputs indicating possible pairing of each track with one of the multiple sensors based on the joint information needs and gain outputs, and.
(e) the modules defined in (a) through (d) repeating the operations until all of the goals specified by the performance requirement inputs have been satisfied for optimally performing sufficient target classification.

19. The system of claim 18 wherein the planning and scheduling module is operative to generate outputs for use in assigning each of the multiple sensors and a respective one of the sensor modes for making the appropriate measurements for the corresponding tracks during a next measurement cycle.

20. The system of claim 19 further comprising
a data fusion module operatively coupled to the planning and scheduling module and to the multiple sensors, the data fusion module being operative following the assigning of multiple sensors to update the states of each track and each sensor cell using the measurements received from the multiple sensors for defining the current state inputs to the first and second groups of modules.

21. The system of claim 20 wherein the sensors classify targets based on measured attributes and only one attribute (a) is measurable by one sensor at a single measurement cycle and the planning and scheduling module operates when a sensor is assigned to a track for the next measurement cycle, sets the value aₜₖ=1, of otherwise sets aₜₖ=0 wherein k and t designate the sensor and track respectively.

22. The system of claim 20 wherein sensors performing a search covering an area of interest (AOI) containing a plurality of search cells, the system further comprising
a module for initiating tracks for all search cells that have reached a desired search detection accuracy as established by the performance requirement inputs.

23. The system of claim 18 wherein:
a first module of the first group of modules computing the kinematic needs for each track using a Kalman filter for kinematic tracking operations wherein P_{before} denotes the current state covariance matrix and P_{D} the desired covariance matrix as specified by the performance requirements defined in terms of tracking accuracy values, Nt represents kinematic information need of a track t, X represents a continuous random variable X and Pt represents the track priority, the kinematic needs being computed according to the following expression:
$${N}_{t} ( X ) = {P}_{t} {log}_{2} ( \frac{\vert {P}_{before} \vert}{\vert {P}_{d} \vert} ) ,$$
the desired kinematic information need Nₜ being positive as long as the desired covariance has not yet been achieved and a high positive value of Nₜ indicating that the track t needs kinematic sensor measurements urgently.

24. The system of claim 18 wherein:
a second module of the first group of modules computes classification needs for each track according to the following expression wherein it is assumed that sensors classify targets based measured attributes and only one attribute is measurable by one sensor at a single sampling time:
Nₜ(C)=Hₜ(C)−H_{t,d}(C)
wherein Nₜ(C) represents the current target classification entropy, Hₜ(C) represents the current classification of a track and H_{t,d}(C) represents the desired target classification entropy of a track wherein a track with high positive value of Nₜ indicates that the track is in more urgent need of a classification or attribute measurement.

25. The system of claim 24 wherein the probability of correct classification P_{c} of a target is the same as the posterior probability of a class c1 with the highest probability as determined as by the system based on an upper and lower bound computed from the remaining classes.

26. The system of claim 24 wherein the probability of correct classification P_{c} of a target for a fully characterized system where a function corresponding to as receiver operating curve ROC that relates the probability of correct classification verses the posterior probability of declared classification P_{d} which is the probability of the class or classification with the highest probability is available, then the declared classification probability corresponding to P_{c} is computed using the function ROC.

27. The system of claim 24 wherein the probability of correct classification P_{c} of a target is computed as a measure of confidence wherein confidence is defined as a number in the range of 0-1 and is given as the ratio of the difference between the highest class probability and the second highest class probability to the highest probability.

28. The system of claim 18 wherein for a given search scenario with some current state:
a third module of the first group of modules computes the search needs of an area of interest (AOI) which is divided into N cells wherein each cell contains at most one target based on desired goals defined by the performance inputs, the third module computing the search needs according to the following expression:
Nₐ(S)=Pₐ(Hₐ(S)−H_{a,d}(S))
wherein Nₐ(S) represents the desired search need of a cell a, Pa represents cell priority, Hₐ(S) represents current target search entropy for a cell and H_{ad}(S) represents the desired entropy state, cells with high Nₐ values being in more urgent need of search measurements.

29. The system of claim 18 wherein:
a first module of the second group of modules computes kinematic gain for each sensor according to the following expression:
$${I}_{t , k} ( X ) = {H}_{before} ( X ) - {H}_{k , after} ( X ) = {log}_{2} ( \frac{\vert {P}_{before} \vert}{\vert {P}_{k , after} \vert} )$$
wherein the expression defines the information gain of the sensor as the difference between the current information state and the predicted information state if the sensor were to make that measurement wherein I_{t,k}(X) represents the kinematic information gain, H_{before}(X) represents the before entropy value and H_{k,after} represents the after entropy value and wherein each sensor k having a positive value from the computed expression is an option for satisfying the information need for track t.

30. The system of claim 18 wherein the classification entropy conditioned on the measurement by sensor k is a weighted sum of the classification entropies conditioned on each of the possible measured attributes by sensor k and wherein:
a second module of the second group of modules computes classification information gain for a sensor k according to the expression:
I_{t,k}(C)=Hₜ(C)−H_{t,k}(C/measurement by sensor k)
wherein I_{t,k}(C) represents the classification information gain of track t, Hₜ(C) represents the current classification information entropy value of track t, and H_{t,k} represents the classification information gain of track t measured by sensor k and wherein all sensors k with a positive value computed from the expression become options for satisfying the information need for track t.

31. The system of claim 18 wherein:
a third module of the second group of modules computes search gain of a cell a due to sensor k measurement according to the following expression:
I_{a,k}(S)=Hₐ(S)−H_{a,k}(S/measurement by sensor k)
wherein I_{a,k}(S) represents the search information gain of a cell, Hₐ(S) represents the current search information gain entropy value and H_{a,k}(S) represents the desired search information gain entropy value and wherein all sensors k with a positive value computed from the expression become options for satisfying the information need for cell a.

32. The system of claim 18 wherein:
the scaling module computes a ratio represented by R of the highest classification entropy output value Hₘₐₓ(C) and the highest kinematic entropy output value Hₘₐₓ(X) is given by the expression:
R=Hₘₐₓ(C)/Hₘₐₓ(X)
wherein all the kinematic (differential) need and gain entropy values are scaled by R for having all need and gain values defined in terms of the same metric reference system.

33. The system of claim 18 wherein the planning and scheduling module further includes a greedy algorithm component which performs the following operations:
sets all the values aₜₖ=0;
selects track t with the highest Nₜ value and pairs it with sensor k that has the highest Iₜₖ value for this track, setting aₜₖ=1;
after completion of the second operation, updates the need of track t as (Nₜ-Iₜₖ) and when that sensor can only do one task at a time, then the module updates the information gain value of this sensor as Iₜₖ=0;
the module repeats operation i until there are no sensors with a positive Iₜₖ value or tracks with positive Nₜ values; and,
wherein a negative Nₜ value for a track means that the track performance goal has been reached and a zero Iₜₖ value for a sensor means that the sensor is not available for any measurement.

34. The system of claim 18 wherein the planning and scheduling module further includes an optimization component which performs a global optimization operation for determining the values of atk's that maximize the following expression:
$$Maximize {\sum }_{i = 1}^{T} {\sum }_{j = 1}^{K} {a}_{tk} ( {I}_{tk} * {N}_{t} ) subject to$$
$${\sum }_{k = 1}^{K} {a}_{tk} \leq 1 ∀ t = 1 , … , T$$
$${\sum }_{t = 1}^{T} {a}_{tk} \leq 1 ∀ k = 1 , … , K$$
with the constraint is that each track must be paired only with a single sensor in addition to constraints pertaining to sensor tasking capacity and handling of multiple measurements.

35. A computer program product for providing closed loop management control of multiple sensors wherein the program product comprises a computer readable storage medium having computer readable program coded instructions embodied in the medium, wherein the program coded instructions comprise:
(a) a first set of instructions for receiving current target/track kinematic, classification, and search state inputs, performance requirements inputs and knowledge base inputs during a measurement cycle;
(b) a second set of instructions for computing kinematic, classification and search needs and gains from the current kinematic, classification and search state inputs, performance requirements inputs and knowledge base inputs received in step (a) to produce a corresponding number of entropy outputs;
(c) a third set of instructions for scaling the kinematic need and gain entropy outputs relative to the classification and search entropy outputs so as to provide a common reference system for determining the total needs and gains of the system;
(d) a fourth set of instructions responsive to the scaled need and gain outputs from step (c) and needs and gains from step (b) for determining joint information needs and gains for each track;
(e) a fifth set of instructions for pairing each track with one of the multiple sensors according to the results of step (d); and,
(f) a sixth set of instructions for repeating steps (a) through (e) until all of the goals defined by the performance requirements for performing sufficient target classification has been optimally achieved.

36. The program product of claim 35 wherein the fourth set of instructions further includes optional instructions responsive to the needs and gains for each track for generating an operator viewable prioritized list of needs tasks and prioritized list of sensor options for satisfying the needs tasks.

37. The program product of claim 35 wherein the fifth set of instructions further includes optional instructions for generating an operator viewable a list of suggested sensor collection plans or schedules.
